(19) United States
(12) Patent Application Publication
(10) Pub. No.: US 2017/0325297 A1
(43) Pub. Date: Nov. 9, 2017

(54) LIGHTING APPARATUS

(71) Applicant: GL VISION INC., Gangwon-do (KR)

(72) Inventor: Eun Mi LEE, Seoul (KR)

(73) Assignee: GL VISION INC., Gangwon-do (KR)

(21) Appl. No.: 15/525,051

(22) PCT Filed: Nov. 3, 2015
(86) PCT No.: PCT/KR2015/011702

§ 371 Date: May 5, 2017

(30) Foreign Application Priority Data
Nov. 7, 2014 (KR) 10-2014-0154749

(51) Int. Cl. H05B 33/08; F21S 2/00; F21K 99/90; F21V 3/02; F21Y 2115/10

(52) U.S. Cl. CPC H05B 33/0803; F21S 2/005; F21K 9/90; F21Y 2115/10; F21V 3/02; Y10S 362/80

(57) ABSTRACT

Provided is a lighting apparatus. The lighting apparatus includes: a light source configured to emit light; a reflective member included an output region of the light and surrounded the output region; and a fluorescent layer formed on a part of a region of the reflective member.

### TECHNICAL FIELD

The present invention relates to a lighting apparatus.

### BACKGROUND ART

A lighting apparatus is an apparatus having a lamp shade through which light emitted from a light source, such as an electric light bulb, is effectively radiated indoors or outdoors. Generally, efficiency of the lighting apparatus varies according to reflection efficiency of the lamp shade.

In a related art, a lighting apparatus includes a fluorescent lamp and a lamp shade. However, power consumption of the fluorescent lamp is high, a life span thereof is short, and there is a problem of heat generation.

Recently, a lighting apparatus that uses a light-emitting diode (LED) instead of a fluorescent lamp has been developed. Methods of realizing white light by using an LED include a method of realizing white light at a package level by applying phosphor to a blue LED, and a three-color LED method in which white and green LED devices are installed to be adjacent to each other so that colors of light emitted from each of the LEDs is mixed to realize white light.

In the three-color LED method, manufacturing costs are relatively high and uniform mixed color, i.e., white light close to natural light, cannot be realized due to different optical characteristics of light-emitting devices.

In addition, in the method of realizing white light at the package level by applying phosphor to a blue LED, a phosphor applying process and a packaging process are additionally performed so that manufacturing costs are high and defects may occur.

### DISCLOSURE

### Technical Problem

The present invention is directed to providing a lighting apparatus using a light-emitting diode (LED).

The present invention is also directed to providing a lighting apparatus that outputs light having a high color rendering index (CRI) and a homogeneous wavelength region.

### Technical Solution

One aspect of the present invention provides a lighting apparatus including: a light source configured to emit light; a reflective member included an output region of the light and surrounded the output region; and a fluorescent layer formed on a part of a region of the reflective member.

The fluorescent layer may be formed on a part of a region of the reflective member adjacent to the light source.

The lighting apparatus may further include a support member disposed at one end of the reflective member and supporting the light source, and the fluorescent layer may be formed on a part of a region of the reflective member adjacent to the support member.

The fluorescent layer may have a predetermined height.

The height of the fluorescent layer may be in a range of 8 mm to 16 mm.

The fluorescent layer may include a plurality of fluorescent bands spaced a predetermined distance apart from each other.

Each of the plurality of fluorescent bands may have a predetermined separation distance.

A width of each of the fluorescent bands may be in a range of 5 mm to 50 mm.

The predetermined separation distance may be in a range of 10 mm to 15 mm.

A ratio of a width to the predetermined separation distance of each of the fluorescent bands may be in a range of 1:3 to 5:1.

The lighting apparatus may further include an auxiliary fluorescent layer facing the fluorescent layer in which the light source is disposed between the fluorescent layer and the auxiliary fluorescent layer.

The auxiliary fluorescent layer may have the same shape as that of the fluorescent layer.

The auxiliary fluorescent layer may be applied to a protruding part of the support member.

The auxiliary fluorescent layer may be formed of the same material as a material used to form the fluorescent layer.

The fluorescent layer may include an inorganic phosphor or an organic phosphor.

The fluorescent layer may include a quantum dot.

The fluorescent layer may include a red fluorescent material.

The fluorescent layer may include phosphor that generates an excited light having a wavelength different from that of a visible light region generated in the light source.

A ratio of a width to a height of the fluorescent layer may be in a range of 8:25 to 2:25.

A height of the fluorescent layer may be determined by a concentration of a phosphor included in the fluorescent layer and a size of the light source.

### Advantageous Effects

In a lighting apparatus according to embodiments, a fluorescent layer is applied to a part of a region of a reflective member so that a color rendering index (CRI) of the lighting apparatus can be increased and light having a homogeneous wavelength range can be output.

In the lighting apparatus according to embodiments, the fluorescent layer is applied so that light having a high CRI is output, a packaging process can be omitted so that manufacturing costs can be reduced, and a defect rate is reduced so that a manufacturing yield can be improved.

### DESCRIPTION OF DRAWINGS

FIG. 1 is a perspective view of a lighting apparatus according to a first embodiment.

FIG. 2 is an exploded perspective view of the lighting apparatus according to the first embodiment.

FIG. 3 is a top view of a support member and a light source according to the first embodiment.

FIG. 4 is a cross-sectional view taken along line A-A′ of FIG. 3.

FIG. 5 is a bottom perspective view of a reflective member according to the first embodiment.

FIG. 6 is a bottom perspective view of a reflective member according to a second embodiment.

FIG. 7 is a bottom perspective view of a reflective member according to a third embodiment.

FIG. 8 is a graph showing a wavelength of light output by lighting apparatuses according to the first through third embodiments.

FIG. 9 is a cross-sectional view of a lighting apparatus according to a fourth embodiment.

### BEST MODE

A lighting apparatus according to embodiments may include: a light source configured to emit light; a reflective member including an output region of the light and surrounding the output region; and a fluorescent layer formed in a part of a region of the reflective member.

### Modes of the Invention

Hereinafter, exemplary embodiments of the present invention will be described in detail. However, the present invention is not limited to the exemplary embodiments disclosed below, but one of ordinary skill in the art who understands the spirit of the invention may easily suggest other regressive inventions or other embodiments within the scope of the spirit of the invention by adding, changing, deleting, etc. other elements in the scope of the same spirit, and these are also included in the scope of the spirit of the invention.

Also, like reference numerals are used for like elements having the same functions in the scope of the same spirit shown in the drawings of each of the embodiments.

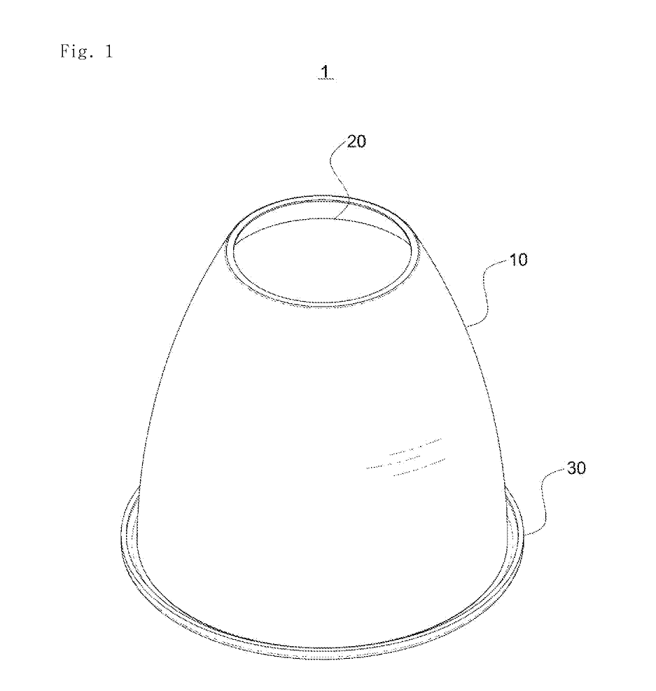

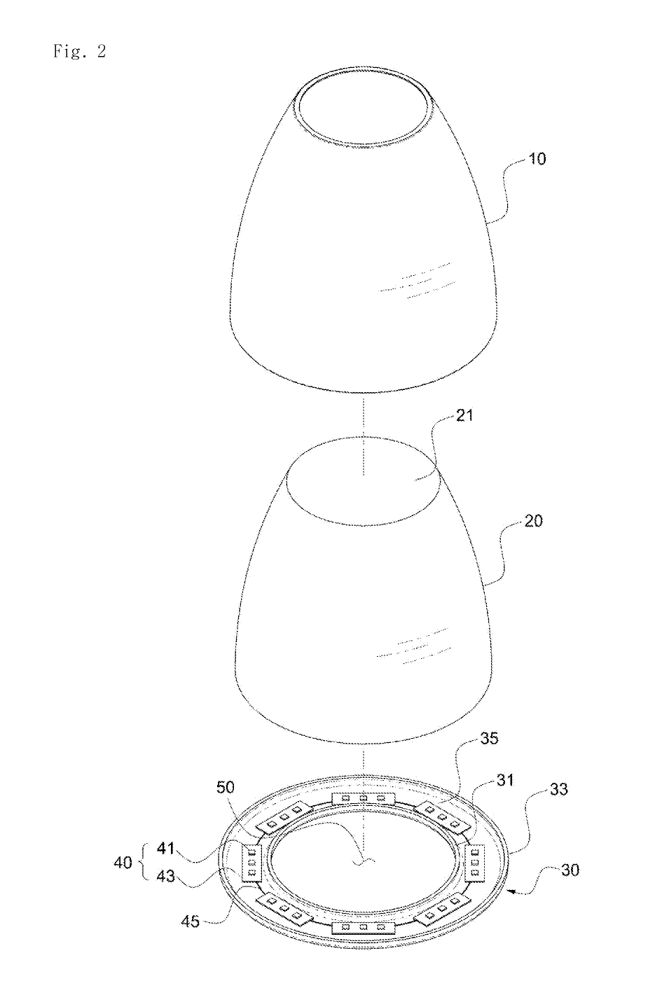

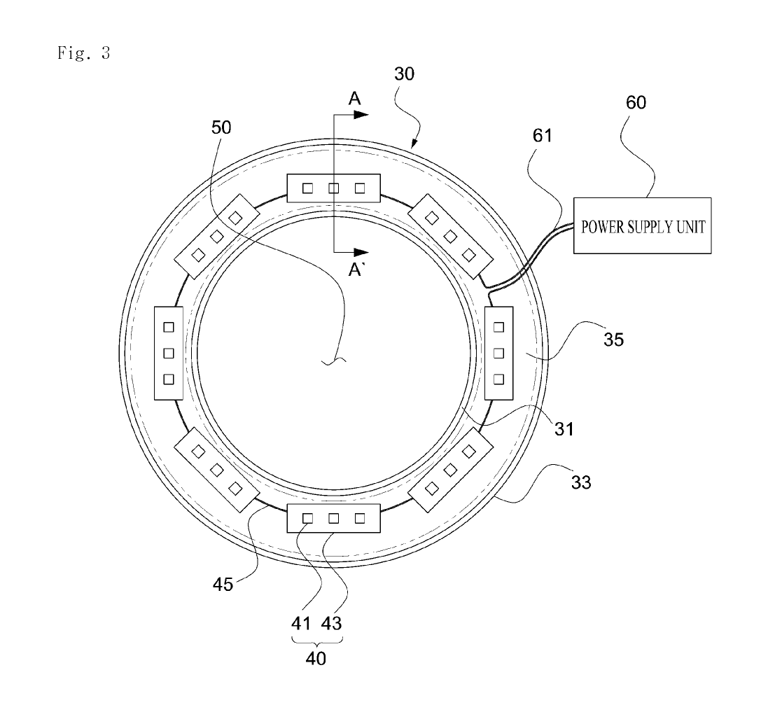

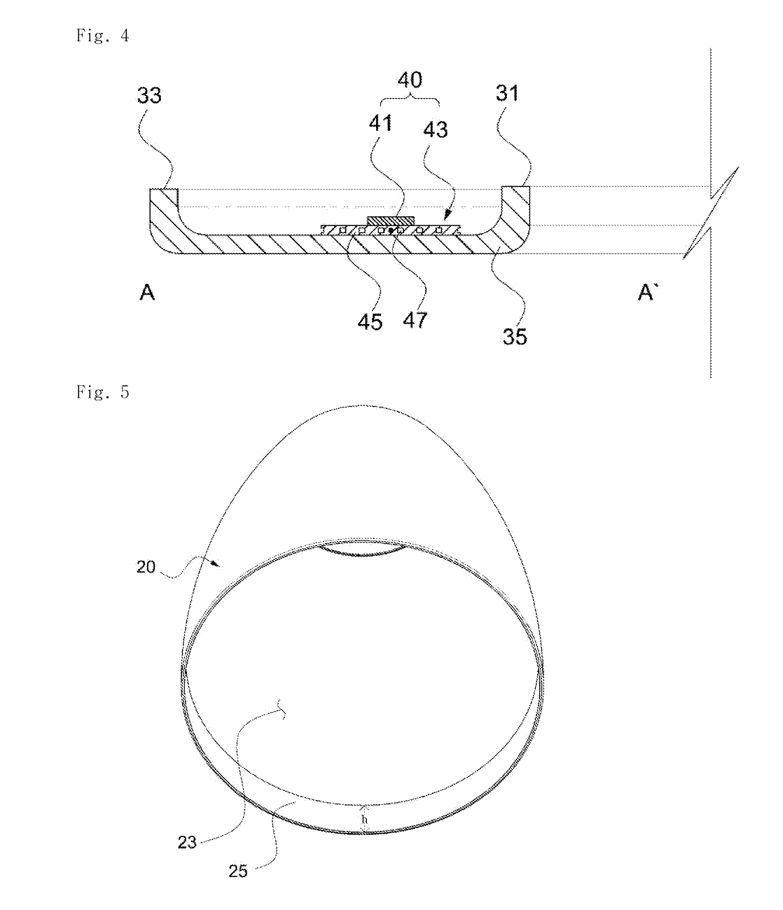

FIG. 1 a perspective view of a lighting apparatus according to a first embodiment, FIG. 2 is an exploded perspective view of the lighting apparatus according to the first embodiment, FIG. 3 is a top view of a support member and a light source according to the first embodiment, and FIG. 4 is a cross-sectional view taken along line A-A′ of FIG. 3.

Referring to FIGS. 1 through 4, a lighting apparatus 1 according to the first embodiment may include a frame 10, a reflective member 20, and a support member 30.

The frame 10 may be a frame or a framework that constitutes a body of the lighting apparatus 1. The frame 10 may have a truncated cone shape with a hollow interior. The frame 10 may have a truncated cone shape with an open bottom surface. The frame 10 may have a truncated cone shape with open top and bottom surfaces.

The frame 10 may have a bell shape with a curved side surface.

Although not shown, the frame 10 may further include a heat dissipating member. Alternatively, the frame 10 may be formed of a material having high thermal conductivity to easily dissipate heat. A heat dissipation capability of the frame 10 is improved so that heat inside the lighting apparatus 1 can be dissipated to the outside, and thus an internal configuration of the lighting apparatus 1 can be prevented from being damaged due to heat.

Although not shown, the heat dissipating member may be formed at an outer surface of the frame 10 or an inner surface thereof. When the heat dissipating member is formed at the inner surface of the frame 10, the heat dissipating member may be formed between the frame 10 and the reflective member 20.

The reflective member 20 may be inserted into an inside of the frame 10. The reflective member 20 having a sheet shape may be fixed to the inside of the frame 10. A part of the reflective member 20 may be attached to the inside of the frame 10 so that the whole reflective member 20 can be fixed to the frame 10.

The reflective member 20 may have a shape corresponding to the frame 10. The reflective member 20 may have a truncated cone shape with a hollow interior. The reflective member 20 may have a truncated cone shape with an open end. The reflective member 20 having the truncated cone shape with the open end may also be defined in a bell shape.

Because the reflective member 20 has a truncated cone shape, one end of the reflective member 20 may have a circular shape. An area of the reflective member 20 may be decreased from the one end to the other end thereof. That is, an area of a region defined by adjacent parallel lines when the reflective member 20 is divided by a plurality of identical parallel lines parallel to the reflective member 20 may be increased from the other end to the one end of the reflective member 20. The reflective member 20 reflects light emitted from a light source, and as the area of the reflective member 20 is increased, a reflective area of the reflective member 20 may be increased. Thus, the reflective area of the reflective member 20 is increased from the other end to the one end of the reflective member 20.

A planar region 21 may be formed in the reflective member 20. The planar region 21 may be connected to the other end of the reflective member 20. The planar region 21 is connected to the other end of the reflective member 20, and thus may have a circular shape. The planar region 21 may be a face parallel to an output region 50. The planar region 21 may include the same material as a material used to form the reflective member 20. The planar region 21 may be formed integrally with the reflective member 20.

When the reflective member 20 has a sheet shape, the reflective member 20 may include a resin layer, a foaming or filling agent (a diffusion agent), a metal layer, and a protective layer. For example, the resin layer may be formed of a material, such as polyethylene terephthalate (PET), polycarbonate (PC), photovoltaic (PV), and polypropylene (PP), and may include a foaming or organic/inorganic filling agent, such as barium sulfate or potassium carbonate. A metal layer, such as aluminum (Al) or silver (Ag), is formed on one surface of the resin layer, and a protective layer for protecting the reflective member 20 is formed on one surface of the metal layer.

An inorganic filling agent for increasing reflectivity of the reflective member 20 may include barium sulfate (BaSO₄), calcium sulfate (CaSO₄), magnesium sulfate (MgSO₄), barium carbonate (BaCO₃), calcium carbonate (CaCO₃), potassium carbonate (K₂CO₃), magnesium chloride (MgCl₂), aluminum hydroxide (Al(OH)₃), magnesium hydroxide (Mg(OH)₂), calcium hydroxide (Ca(OH)₂), titanium dioxide (TiO₂), alumina (Al₂O₃), silica (SiO₂), talc (H₂Mg₃(SiO₃)₄ or Mg₃Si₄O₁₀(OH)₂), or zeolite. Also, the reflective member 20 may not include a metal layer. Also, an ultraviolet (UV) absorbing layer (a degradation preventing layer) may be additionally included in one surface of the resin layer or may be included in the resin layer.

A thickness of the reflective member 20 may be in a range of 0.015 to 15 mm. Reflectance of the reflective member 20 may be in a range of 60% to 99.8%. Also, according to another embodiment, the reflective member 20 may not include a diffusion pattern or a filling agent and may be a sheet having very high reflectance. In this case, the reflectance of the reflective member 20 is high so that a quantity of light loss is small, and thus a radiation amount of emitted light can be increased.

A photocatalyst may be applied to a light reflective surface of the reflective member 20 to prevent dust adsorption thereon.

The photocatalyst may include a titanium compound represented by TiOx:D. Here, D represents a dopant, and the dopant may include nitrogen (N), carbon (C), —OH, iron (Fe), chromium (Cr), cobalt (Co), or vanadium (V). The titanium compound may be titanium dioxide (TiO₂) or titanium oxynitride (TiON), and may be coated on the light reflective surface using minute particles with a hydrophilic property. A particle diameter of the photocatalyst may be in a range of several nm or several hundreds of nm. For example, the particle diameter of the photocatalyst may be in a range of 5 to 900 nm.

Also, the photocatalyst may be applied to the reflective member 20 when a binder or solution including the photocatalyst is coated on the surface of the reflective member 20 and dried. A thickness of the binder or solution including the photocatalyst may be in a range of 0.05 to 20 μm after the binder or solution is dried.

Electrical characteristics of the titanium compound represent characteristics of a semiconductor, and when a UV ray having a short wavelength of less than 380 nm or visible light having a wavelength of 380 to 780 nm is radiated, the titanium compound enters into an excited state, and thus represents a strong oxidizing power and is a chemically stable material. That is, when the titanium compound absorbs UV rays or visible light, electrons and holes are generated on a surface of the titanium compound, and the generated electrons and holes are used to decompose most harmful substances.

The photocatalyst has a hydrophilic effect, and thus a dustproof effect. That is, when water is sprayed onto the surface of the reflective member 20 coated with the photocatalyst, a contact angle between the sprayed water drops and a surface of a base material is decreased so that the hydrophilic effect of the surface of the reflective member 20 occurs, and due to the characteristic, dust can be prevented from being adsorbed onto the surface of the reflective member 20.

Also, the photocatalyst has an oxidizing and decomposing power of various organic materials (carbon compounds), and due to these functions, the photocatalyst decomposes smell induction materials such as ammonia, hydrogen sulfide, trimethylamine, methyl mercaptan, dimethyl sulfide, methyl disulfide, and styrene so that deodorization, air cleaning, and sterilization/anti-bacterial effects can be attained.

A photocatalyst in a liquid state may be sprayed onto the surface of the reflective member 20 and coated. That is, a user sprays the liquid photocatalyst onto the surface of the reflective member 20 by using a spraying tool to conveniently apply the photocatalyst to the surface of the reflective member 20.

Also, the photocatalyst may be applied to the surface of the reflective member 20 by using a screen printing method, a gravure printing method, a spraying method, or a roll brushing after spraying method.

The screen printing method is a printing method in which a liquid including the photocatalyst is uniformly applied through a minute mesh formed in a printing screen, the gravure printing method is a printing method in which a liquid including the photocatalyst coated on a concave roller is applied to the surface of the reflective member 20, the spraying method is a method in which a liquid including the photocatalyst is sprayed onto the surface of the reflective member 20, and the roll brushing after spraying method is a method in which a liquid including the photocatalyst is sprayed onto the surface of the reflective member 20 and then is uniformly rubbed with a roll brush and is coated thereon.

According to the current embodiment, the photocatalyst can be efficiently applied to a large area of reflective member 20 by using the printing method.

Also, the reflective member 20 may be pre-treated with an organic or inorganic solvent before the photocatalyst is applied thereto. That is, after an organic/inorganic contaminant is cleaned from the surface of the reflective member 20 using the organic or inorganic solvent, the photocatalyst can be applied to the cleaned surface of the reflective member 20. Here, the organic or inorganic solvent may be an alkali chemical and a neutral detergent, such as acetone or alcohol.

Also, after a coating layer formed of silver nano or aluminum nano is formed on the surface of the reflective member 20, the photocatalyst may also be applied to the coating layer. Due to the silver nano or alumina nano layer, reflection efficiency of a reflection assistance apparatus can be improved.

Also, the photocatalyst may further include an additive that controls viscosity thereof.

The reflective member 20 may be formed by coating an inside of the frame 10 with a material. The inside of the frame 10 is coated with a material having high reflectivity so that the material having high reflectivity can be used to form the reflective member 20.

The support member 30 may be disposed at one end of the frame 10 and the one end of the reflective member 20. The support member 30 may be formed to have a shape corresponding to the one end of the reflective member 20. The support member 30 may be formed to have a shape corresponding to the one end of the frame 10. Because the one end of the frame 10 and the one end of the reflective member 20 are formed to have a circular band shape, the support member 30 may have a circular band shape.

A central region of the support member 30 may be open. The central region of the support member 30 may be open and may have the output region 50. That is, the output region 50 may be defined by the support member 30 having the circular band shape. A circumference of the output region 50 may be defined by the open support member 30.

The output region 50 may have a circular shape. Although not shown, an emission sheet may be attached to the output region 50. The emission sheet may transmit all light propagating into the output region 50. The emission sheet may block foreign substances from being introduced into the lighting apparatus 1. The emission sheet may block foreign substances from being introduced into the lighting apparatus 1 and may prevent reflectivity of the reflection member 20 from being lowered by the foreign substances.

Although not shown, a reflection sheet may be attached to a top surface of the support member 30. The reflective sheet attached to the top surface of the support member 30 may be the same sheet as the reflective member 20. Alternatively, a reflective material may be applied to the top surface of the support member 30.

The reflective sheet may be attached to the top surface of the support member 30 or the reflective material may be applied to the top surface of the support member 30 so that light propagating toward the support member 30 can be reflected in a direction of the reflective member 20 and can be emitted through the output region 50. Thus, light quantity of the lighting apparatus 10 can be increased, and power consumption in comparison to the same light quantity can be reduced.

Although not shown, the support member 30 may further include a heat dissipating member. Alternatively, the support member 30 may be formed of a material having high thermal conductivity so that heat dissipation can be easily performed. The support member 30 may be formed of a metallic material having high thermal conductivity. A heat dissipation capability of the support member 30 is improved so that heat inside the lighting apparatus 1 can be dissipated to the outside and the internal configuration of the lighting apparatus 1 can be prevented from being damaged by heat.

The support member 30 may include a first protruding region 31, a second protruding region 33, and a support region 35. The first protruding region 31 may protrude from an inside of the support member 30 toward the frame 10. The second protruding region 33 may protrude from an outside of the support member 30 toward the frame 10.

The support region 35 may connect the first protruding region 31 and the second protruding region 33. That is, the first protruding region 31 and the second protruding region 33 may protrude from both side regions of the support region 35 toward the frame 10. The first protruding region 31, the second protruding region 33, and the support region 35 may be integrally formed. The support region 35 may support a light source 40.

The first protruding region 31 may be formed between the support region 35 and the output region 50. The first protruding region 31 is formed between the support region 35 and the output region 50 so that light emitted from the light source 40 directly toward the output region 50 can be blocked. That is, the first protruding region 31 may prevent the light emitted from the light source 40 from being emitted into the output region 50 without a reflection process using the reflective member 20, and may prevent dazzling at a predetermined angle.

The first protruding region 31 and the second protruding region 33 may protrude from both of the side regions of the support region 35 so that a horizontal flow of the frame 10 and the reflective member 20 can be prevented. The first protruding region 31 and the second protruding region 33 may prevent the horizontal flow of the frame 10 and the reflective member 20 so that stability of the lighting apparatus 1 can be improved. Also, the first and second protruding regions 31 and 33 may prevent a horizontal flow of the light source 40 so that stability of the lighting apparatus 1 can be improved.

The light source 40 may be disposed on the support member 30. The light source 40 may be disposed in the support region 35 of the support member 30. The light source 40 may be disposed to correspond to the shape of the support member 30. The light source 40 may be disposed to have a shape corresponding to the one end of the reflective member 20. The light source 40 may be disposed in a circular band shape. The light source 40 may be disposed to surround the output region 50. The light source 40 may be disposed in a closed loop shape that surrounds the output region 50. The light source 40 may be disposed along the circumference of the output region 50.

The light source 40 may include a plurality of light-emitting diodes (LEDs) 41 and a plurality of printed circuit boards (PCBs) 43.

The plurality of LEDs 41 may be LEDs or organic light-emitting diodes (OLEDs).

The LEDs 41 may be formed on the PCBs 43. The LEDs 41 may be attached to one surface of each of the PCBs 43. The LEDs 41 may be mounted on the PCBs 43. The LEDs 41 having a package shape may be mounted on the PCBs 43, or the LEDs 41 having a chip on board (COB) shape may be mounted on the PCBs 43.

The plurality of LEDs 41 may be disposed to correspond to the shape of the support member 30. The plurality of LEDs 41 may be disposed to have a shape corresponding to the one end of the reflective member 20. The plurality of LEDs 41 may be disposed in a circular band shape. The plurality of LEDs 41 may be disposed to surround the output region 50. The plurality of LEDs 41 may be disposed in a closed loop shape that surrounds the output region 50. The plurality of LEDs 41 may be disposed along the circumference of the output region 50.

The plurality of LEDs 41 may be formed on the plurality of PCBs 43. The plurality of LEDs 41 may be mounted on one PCB 43. The PCBs 43 on which the plurality of LEDs 41 are mounted may be electrically connected to one another via a connection wiring 45.

Power required for driving the LEDs 41 may be applied to the plurality of LEDs 41 using a power supply unit 60. The power supply unit 60 may be connected to the PCB 43 via a power wiring 61, and may transfer power to the PCB 43. The PCB 43 to which power is applied from the power supply unit 60 simultaneously supplies power to the LEDs 41 mounted thereon and transfers power to an adjacent PCB 43 via the connection wiring 45. The adjacent PCB 43 simultaneously supplies power to the LEDs 41 mounted thereon and transfers power to another PCB 43 via the connection wiring 45. By repeating the above procedure, power is applied to the plurality of LEDs 41 so that all of the LEDs 41 emit light.

The power supply unit 60 may include an alternating current (AC) to direct current (DC) converter (ADC) that converts an AC into a DC. The power supply unit 60 may convert an AC power from the outside into a DC power and may transfer the DC power to the PCBs 43. The power supply unit 60 may depressurize the converted DC power and may transfer the depressurized DC power to the PCBs 43.

The power supply unit 60 may be disposed outside the lighting apparatus 1. Alternatively, the power supply unit 60 may be disposed inside the lighting apparatus 1. Although not shown, when the power supply unit 60 is disposed inside the lighting apparatus 1, the power supply unit 60 in a chip shape may be mounted on at least one of the plurality of PCBs 43.

When the power supply unit 60 includes only an ADC function, an additional DC-DC converter may be mounted on the PCBs 43. The DC-DC converter may convert a power voltage transferred from the power supply unit 60 to correspond to a driving voltage of the LEDs 41 and may transfer the converted power voltage to the LEDs 41 and the adjacent PCBs 43.

The power supply unit 60 is mounted on the PCBs 43 so that the lighting apparatus 1 can operate and be integrally installed thereon without an additional power supply unit 60, and thus installation and transportation of the lighting apparatus 1 can be easily performed.

The PCBs 43 may include a metallic material. The PCBs 43 may be metal PCBs including a material such as aluminum (Al) and copper (Cu). The PCBs 43 may be FR1, FR4, or CEM1 PCBs. The PCBs 43 may include epoxy or phenol.

Also, the PCBs 43 may be flexible PCBs that can be bent by an external force.

Each of the PCBs 43 may include a filling unit 45 and a heat dissipating unit 47.

The filling unit 45 may be a region that is a framework or frame of the PCB 43 and a region filled with the metallic material. The heat dissipating unit 47 may be a region that is not filled with the metallic material.

The heat dissipating unit 47 may be an empty space that is not filled with the metallic material. The heat dissipating unit 47 may be formed inside the PCB 43. The heat dissipating unit 47 may also be formed along sides of the PCB 43. A contact area between the filling unit 45 and the outside is increased, and heat generated in the LEDs 41 and the PCBs 43 can be easily dissipated to the outside due to the heat dissipating unit 47. Thus, defects of the LEDs 41 and the PCBs 43 due to heat can be reduced.

Also, heat from the LEDs 41 may be transferred to the support member 30 via the PCBs 43, and the support member 30 having high thermal conductivity may dissipate heat to the outside so that damage to the LEDs 41 and the PCBs 43 due to heat can be reduced.

FIG. 5 is a bottom perspective view of a reflective member according to the first embodiment.

Referring to FIG. 5, the reflective member 20 according to the first embodiment may include a bell-shaped reflective inner surface 23. The reflective inner surface 23 is an inner surface from which light from the light source 40 is reflected.

A fluorescent layer may be formed in a part of a region of the reflective inner surface 23. The fluorescent layer may be formed in a band shape, i.e., may be formed on the reflective inner surface 23 to have a shape of a fluorescent band 25.

The fluorescent band 25 may be attached to the reflective inner surface 23, or a fluorescent material may be applied to the reflective inner surface 23 so that the fluorescent band 25 can be formed.

The fluorescent band 25 may be formed in a lower region of the reflective inner surface 23. The fluorescent band 25 may be formed in a part of a region of the reflective inner surface 23 adjacent to the light source 40. The fluorescent band 25 may be formed in the lower region of the reflective inner surface 23 spaced apart from the planar region 21. The fluorescent band 25 may be formed adjacent to one end of the reflective inner surface 23 adjacent to the light source 40 or spaced a predetermined distance apart from the one end of the reflective inner surface 23 adjacent to the light source 40.

The fluorescent band 25 may be formed to have a predetermined height h. The fluorescent band 25 may be formed to have the height h of 8 to 16 mm. Preferably, the fluorescent band 25 may be formed to have the height h of 16 mm.

The fluorescent band 25 may include an inorganic phosphor or an organic phosphor. The fluorescent band 25 may also include a quantum dot.

A concentration of the phosphor of the fluorescent band 25 may be in a range of 10% to 50%. Preferably, the concentration of the phosphor of the fluorescent band 25 may be 20%.

A height of the fluorescent band 25 may vary according to the concentration of the phosphor. For example, when a concentration of the fluorescent band 25 increases, the height of the fluorescent band 25 may be decreased. When the height of the fluorescent band 25 is high, the quantity of light reflected by the reflective member 20 is reduced, and thus light efficiency may be decreased. Thus, when the concentration of the fluorescent band 25 is controlled to express a desired correlated color temperature (CCT), the height of the fluorescent band 25 can be reduced.

Also, the height of the fluorescent band 25 may be determined according to a size of the phosphor. For example, when the size of the phosphor is large, a desired CCT can be expressed even when the fluorescent band 25 having a small height is used. Thus, the height of the fluorescent band 25 may be reduced so that light efficiency can be improved.

Also, the height of the fluorescent band 25 may be determined by a size of the light source 40. Because intensity of output light varies according to the size of the light source 40, the height of the fluorescent band 25 is adjusted according to the intensity of the light so that light efficiency can also be improved.

The phosphor may generate an excited light having a wavelength different from that of a visible light region generated in the light source 40.

The fluorescent band 25 may be formed of a material selected from the group consisting of at least one phosphor selected from the group consisting of YBO3: Ce3+,Tb3+; BaMgAl10O17:Eu2+,Mn2+; (Sr,Ca,Ba)(Al,Ga)2S4:Eu2+; ZnS:Cu,Al; Ca8Mg(SiO4)4Cl2: Eu2+,Mn2+; Ba2SiO4: Eu2+; (Ba,Sr)2SiO4:Eu2+; Ba2(Mg,Zn)Si2O7:Eu2+; (Ba,Sr)Al2O4: Eu2+; Sr2Si3O8.2SrCl2:Eu2+; (Sr,Mg,Ca)10(PO₄)6Cl2:Eu2+; BaMgAl10O17:Eu2+; BaMg2Al16O27:Eu2+; Sr,Ca,Ba,Mg) P2O7:Eu2+,Mn2+; (CaLa2S4:Ce3+; SrY2S4: Eu2+; (Ca,Sr)S: Eu2+; SrS:Eu2+; Y2O3: Eu3+,Bi3+; YVO4: Eu3+,Bi3+;Y2O2S:Eu3+,Bi3+, and Y2O2S:Eu3+.

The quantum dot is a material that is a nano-sized semiconductor material and expresses a quantum confinement effect. When the quantum dot absorbs light from an excitation source and reaches an energy excited state, the quantum dot emits energy corresponding to an energy band gap of a corresponding quantum dot. Thus, when a size or composition of the quantum dot is controlled, a corresponding energy band gap can be controlled so that the quantum dot can emit various kinds of light and thus can be used as a luminous body for an electronic device.

The nano-sized semiconductor material may be selected from an II-VI group compound, an III-V group compound, an IV-VI group compound, an IV group compound, or a mixture thereof.

The II-VI group compound may be selected from the group consisting of a two-element compound such as CdSe, CdTe, ZnS, ZnSe, ZnTe, ZnO, HgS, HgSe, and HgTe, a three-element compound such as CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, and HgZnSe, or a four-element compound such as HggZnTe, CdZnSeS, CdZnSeTe, CdZnSTe, CdHgSeS, CdHgSeTe, CdHgSTe, HgZnSeS, HgZnSeTe, and HgZnSTe.

The III-V group compound may be selected from the group consisting of a two-element compound such as GaN, GaP, GaAs, GaSb, AlN, AlP, AlAs, AlSb, InN, InP, InAs, and InSb, a three-element compound such as GaNP, GaNAs, GaNSb, GaPAs, GaPSb, AlNP, AlNAs, AlNSb, AlPAs, AlPSb, InNP, InNAs, InNSb, InPAs, InPSb, and GaAlNP, or a four-element compound such as GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, and InAlPSb.

The IV-VI group compound may be selected from the group consisting of a two-element compound such as SnS, SnSe, SnTe, PbS, PbSe, and PbTe, a three-element compound such as SnSeS, SnSeTe, SnSTe, PbSeS, PbSeTe, PbSTe, SnPbS, SnPbSe, and SnPbTe, or a four-element compound such as SnPbSSe, SnPbSeTe, and SnPbSTe.

The IV group compound may be selected from the group consisting of a single element compound such as Si and Ge, or a two-element compound such as SiC and SiGe.

A crystalline structure of the two-element compound, the three-element compound, or the four-element compound may be partially divided and may be present in the same particles or in an alloy form.

The fluorescent band 25 may include a red fluorescent material. The fluorescent band 25 includes the red fluorescent material so that light from the light source 40 can be reflected by the fluorescent band 25 to improve a CRI and can be output to the outside. Also, the fluorescent band 25 includes a phosphor and/or a quantum dot so that a desired CCT can be obtained.

When natural light (similar to black body radiation) and artificially-produced light having the same color temperature are radiated toward the same object, the CRI represents a degree to which a color of an object varies and indicates how close the artificial light is to the natural light, i.e., black body radiation set to 100. As the CRI approaches 100, an emission apparatus realizes white light close to the natural light.

The CRI of the light output from the lighting apparatus is increased due to the fluorescent band 25 so that white light close to the natural light can be output. Light having a high CRI can be output using a simple structure such as the fluorescent band 25 so that manufacturing costs can be reduced in comparison to an implementation of light having a high CRI due to a package structure, defects that may occur in a packaging process can be reduced, and a manufacturing yield can be improved.

Also, the phosphor of the fluorescent band 25 and a density and type of the quantum dot are controlled to control color temperature so that light having a CCI can be obtained in a simple manner.

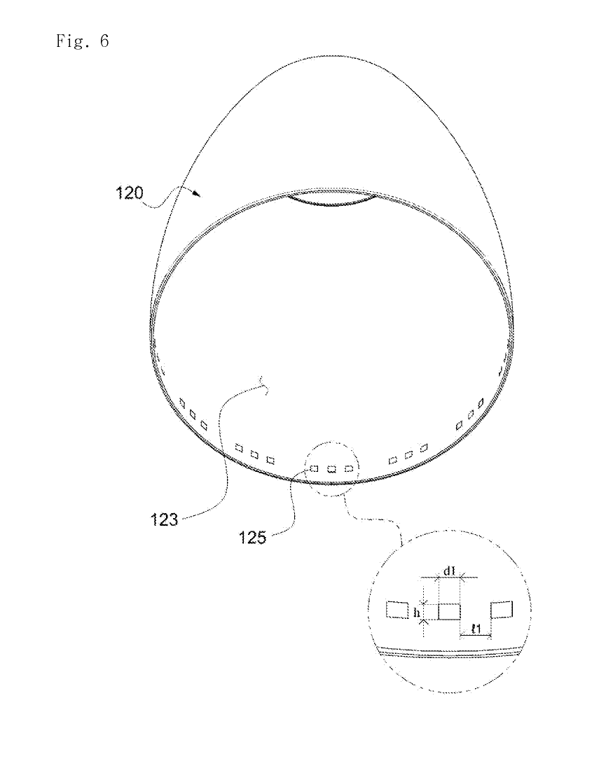

FIG. 6 is a bottom perspective view of a reflective member according to a second embodiment.

When the second embodiment is compared to the first embodiment, an arrangement shape of a fluorescent band is different from that of the first embodiment, and the other configurations thereof are the same as those of the first embodiment. Thus, when describing the second embodiment, like drawing numbers are used for common configurations of the second embodiment with respect to the first embodiment, and detailed descriptions thereof will be omitted.

Referring to FIG. 6, a reflective member 120 according to the second embodiment may include a bell-shaped reflective inner surface 123. The reflective inner surface 123 is an inner surface from which light from a light source is reflected.

A fluorescent layer may be formed in a part of a region of the reflective inner surface 123. The fluorescent layer may be formed on the reflective inner surface 123 to have a shape of a plurality of fluorescent bands 125 formed in a band shape.

The plurality of fluorescent bands 125 may be attached to the reflective inner surface 123, and a fluorescent material may be applied to the reflective inner surface 123 so that the fluorescent bands 125 can be formed.

The fluorescent bands 125 may be formed in a lower region of the reflective inner surface 123. The fluorescent bands 125 may be formed in a part of a region of the reflective inner surface 123 which is adjacent to a light source 40. The fluorescent bands 125 may be formed in the lower region of the reflective inner surface 123 spaced apart from the planer region 21. The fluorescent bands 125 may be spaced apart from one end of the reflective inner surface 123 adjacent to the light source 40.

The fluorescent bands 125 may be formed in a quadrangle shape. The fluorescent bands 125 may be formed in a rectangular shape. Each of the fluorescent bands 125 may have a first separation distance 11 with an adjacent fluorescent band. The fluorescent bands 125 may be formed to have a predetermined height h, and the fluorescent bands 125 may be formed to have a first width d1.

The height h may be in a range of 8 to 16 mm. Preferably, the height h may be 8 mm. The first width d1 may be in a range of 5 to 10 mm. Preferably, the first width d1 may be 5 mm. The first width d1 and the height h of each of the fluorescent bands 125 may have a predetermined ratio. The ratio of the first width d1 to the height h of each of the fluorescent bands 125 may be in a range of 16:5 to 4:5. The ratio of the first width d1 to the height h of each of the fluorescent bands 125 may preferably be 8:5.

The first separation distance 11 may be in a range of 10 to 15 mm. The first separation distance 11 may preferably be 15 mm.

The fluorescent bands 125 may include an inorganic phosphor or an organic phosphor. Each of the fluorescent bands 125 may include a quantum dot.

The fluorescent layer is formed of the plurality of fluorescent bands 125 so that light having a high CRI can be output and light having a homogeneous wavelength can be output.

The fluorescent bands 125 may be formed in a region corresponding to the light source 40. The same number of fluorescent bands 125 as the number of light sources 40 may be formed. The fluorescent bands 125 may be formed in one-to-on correspondence to regions corresponding to the light sources 40. The fluorescent bands 125 are formed only in the region corresponding to the light source 40 so that light emitted from the light source 40 is excited in a primarily-reflected region and reflectance degradation caused by the reflective member 120 can be minimized. Thus, light efficiency can be improved.

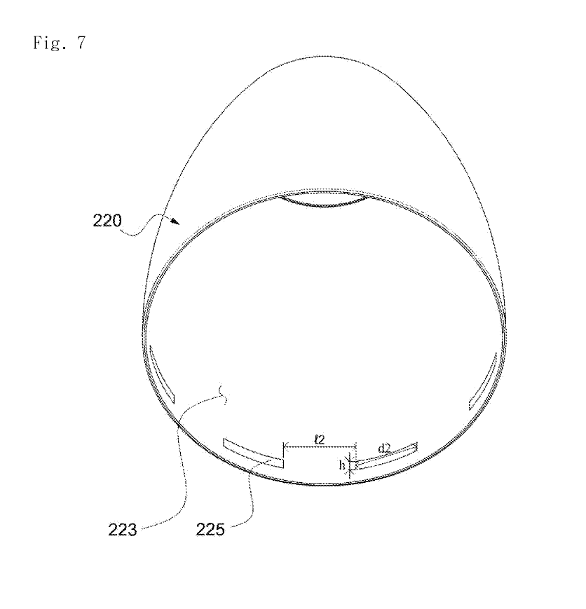

FIG. 7 is a bottom perspective view of a reflective member according to a third embodiment.

When the third embodiment is compared with the second embodiment, an arrangement shape of a fluorescent band is different from that of the second embodiment, and the other configurations thereof are the same as those of the second embodiment. Thus, when describing the third embodiment, like drawing numbers are used for common configurations of the third embodiment with respect to the second embodiment, and detailed descriptions thereof will be omitted.

Referring to FIG. 7, a reflective member 220 according to the third embodiment may include a bell-shaped reflective inner surface 223. The reflective inner surface 223 is an inner surface from which light from a light source is reflected.

A fluorescent layer may be formed in a part of a region of the reflective inner surface 223. The fluorescent layer may be formed on the reflective inner surface 223 to have a shape of a plurality of fluorescent bands 225 formed in a band shape.

The plurality of fluorescent bands 225 may be attached to the reflective inner surface 223, and a fluorescent material may be applied to the reflective inner surface 223 so that the fluorescent bands 225 can be formed.

The fluorescent bands 225 may be formed in a lower region of the reflective inner surface 223. The fluorescent bands 225 may be formed in a part of a region of the reflective inner surface 223 which is adjacent to the light source 40. The fluorescent bands 225 may be formed in the lower region of the reflective inner surface 223 spaced apart from the planer region 21. The fluorescent bands 225 may be spaced apart from one end of the reflective inner surface 223 adjacent to the light source 40.

The fluorescent bands 225 may be formed in a quadrangle shape. The fluorescent bands 225 may be formed in a rectangular shape. Each of the fluorescent bands 225 may have a second separation distance 12 with an adjacent fluorescent band. The fluorescent bands 225 may be formed to have a predetermined height h, and the fluorescent bands 225 may be formed to have a second width d2.

The height h may be in a range of 8 to 16 mm. Preferably, the height h may be 8 mm. The second width d2 may be in a range of 50 to 100 mm. Preferably, the second width d2 may be 50 mm. The second width d2 and the height h of each of the fluorescent bands 225 may have a predetermined ratio. The ratio of the second width d2 to the height h of each of the fluorescent bands 225 may be in a range of 8:25 to 2:25. The ratio of the second width d2 to the height h of each of the fluorescent bands 225 may preferably be 4:25.

The second separation distance 12 may be in a range of 10 to 15 mm. The second separation distance 12 may preferably be 10 mm.

The fluorescent bands 225 may include an inorganic phosphor or an organic phosphor. Each of the fluorescent bands 225 may include a quantum dot.

The fluorescent layer is formed of the plurality of fluorescent bands 225 so that light having a high CRI can be output and light having a homogeneous wavelength can be output.

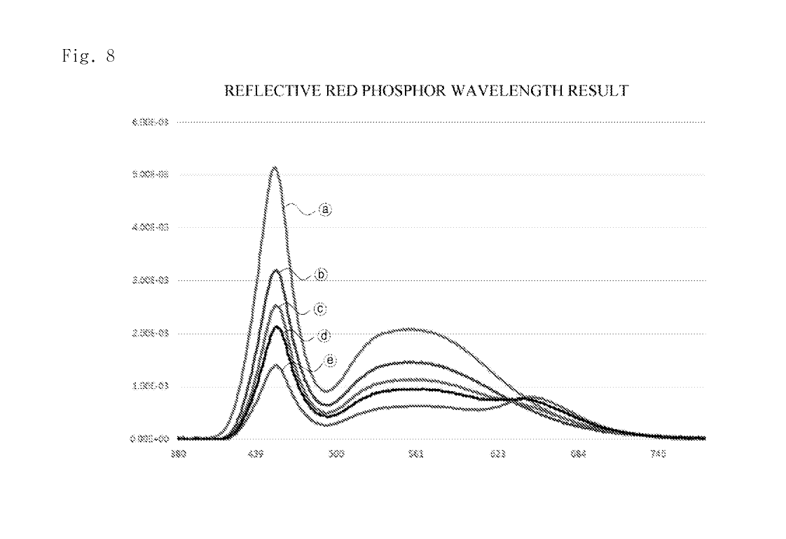

FIG. 8 is a graph showing a wavelength of light output from the lighting apparatuses according to the first through third embodiments, and Table 1 shows characteristics of the light output from the lighting apparatuses according to the first through third embodiments.

TABLE 1

| | | | First | First | First | | |
|---|---|---|---|---|---|---|---|
| | | Reflective | embodiment | embodiment | embodiment | Second | Third |
| Remarks | LED | member | (h = 16) | (h = 32) | (h = 8) | embodiment | embodiment |
| lm/W | 21.27 | 14.83 | 10.40 | 8.56 | 12.24 | 14.03 | 12.9 |
| CRI | 82.1 | 82.25 | 87.2 | 73.1 | 90.44 | 87.1 | 91.9 |
| CCT(k) | 9749 | 8055 | 5753 | 3533 | 6191 | 7397 | 6795 |

FIG. 8 shows a distribution of light according to wavelength of the light output from the lighting apparatus, a represents a curve of light output from the LED 41 included in the light source 40, b represents a curve of light output through a reflective member having no fluorescent layer formed therein, c represents a curve of output light in the first embodiment when h is 16, d represents a curve of light output from the lighting apparatus according to the second embodiment, and e represents a curve of light output from the lighting apparatus according to the third embodiment.

Referring to Table 1 and FIG. 8, light emitted from an LED that does not pass through a reflective member and a fluorescent layer may have a light efficiency of 21.271 m/W and may have a CRI of 82.1 and a CCT of 9749 k. Also, due to characteristics of the LED, the LED outputs light having a high ratio of a blue wavelength.

Also, light output through a reflective member having no fluorescent layer formed therein may have a light efficiency of 14.831 m/W and may have a CRT of 82.25 and a CCT of 8055 k. Also, due to the reflective member, light having a decreased ratio of a blue wavelength due to the reflective member is output, however the ratio is still high.

The light output from the lighting apparatus having the fluorescent layer formed therein according to the first embodiment has lower light efficiency than the light output through the LED that does not pass through the reflective member and the reflective member having no fluorescent layer formed therein, but may have a high CRI. Also, relatively homogeneous light having a low ratio of a blue wavelength can be output.

Light output through a reflective member formed with fluorescent bands having a height of 16 mm may have a light efficiency of 10.401 m/W, a CRI of 87.2, and a CCT of 5753 k.

Light output through a reflective member formed with fluorescent bands having a height of 32 mm may have a light efficiency of 8.561 m/W, a CRI of 73.1, and a CCT of 3533 k.

Light output through a reflective member formed with fluorescent bands having a height of 8 mm may have a light efficiency of 12.241 m/W, a CRI of 90.44, and a CCT of 6191 k.

According to the second embodiment, light output through a reflective member having fluorescent bands each having the height h of 8 mm, the first width d1 of 5 mm, and the first separation distance 11 of 15 mm may have a light efficiency of 14.031 m/W, a CRI of 87.1, and a CCT of 7397 k. Light output from the lighting apparatus according to the second embodiment may have a 5.3% reduction in light efficiency, but may have a high CRI and a homogeneous wavelength range. When each of the fluorescent bands 125 of the second embodiment has the ratio of the first width d1 to the first separation distance 11 of 1:3, light having high efficiency and a high CRI can be output.

According to the third embodiment, light output through a reflective member having fluorescent bands each having the height h of 8 mm, the second width d2 of 50 mm, and the second separation distance 12 of 10 mm may have a light efficiency of 12.91 m/W, a CRI of 91.9, and a CCT of 6795 k. Light output from the lighting apparatus according to the third embodiment may have a 13% reduction in light efficiency but may have a high CRI and a homogeneous wavelength range. When each of the fluorescent bands 225 of the third embodiment has the ratio of second width d2 to the second separation distance 12 of 5:1, light having high efficiency and a high CRI can be output.

Thus, when the ratio of the width to the separation distance of the fluorescent band is in a range of 1:3 to 5:1, light having high efficiency, a high CRI, and a homogeneous wavelength range can be output.

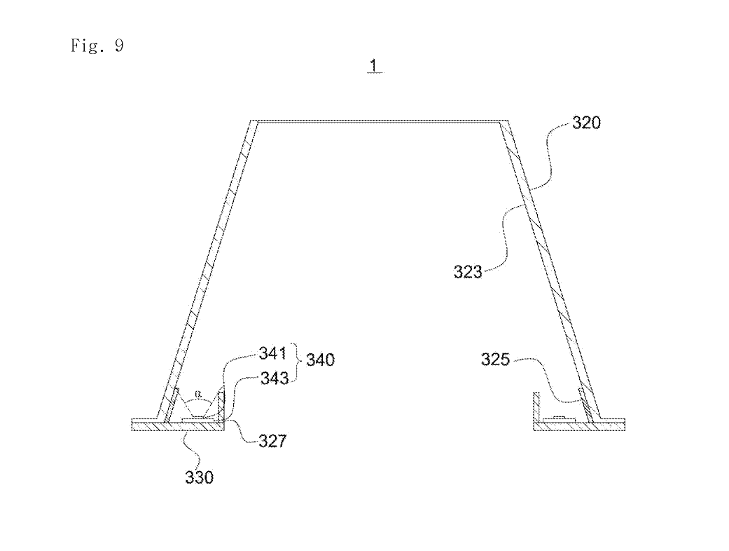

FIG. 9 is a cross-sectional view of a lighting apparatus according to a fourth embodiment.

The lighting apparatus according to the fourth embodiment is the same as the lighting apparatus according to the first embodiment except that the lighting apparatus according to the fourth embodiment further includes an auxiliary fluorescent layer. Thus, when describing the fourth embodiment, like drawing numbers are used for common configurations of the fourth embodiment with respect to the first embodiment, and detailed descriptions thereof will be omitted.

Referring to FIG. 9, a lighting apparatus 1 according to the fourth embodiment includes a reflective member 320. The reflective member 320 may include a bell-shaped reflective inner surface 323. The reflective inner surface 323 is an inner surface from which light from a light source 340 is reflected.

A fluorescent layer may be formed in a part of a region of the reflective inner surface 323. The fluorescent layer may be formed on the reflective inner surface 323 to have a shape of a fluorescent band 325 formed in a band shape.

The fluorescent band 325 may be attached to the reflective inner surface 323, and a fluorescent material may be applied to the reflective inner surface 323 so that the fluorescent band 325 can be formed.

The lighting apparatus 1 may further include an auxiliary fluorescent layer 327. The auxiliary fluorescent layer 327 may be formed in a region adjacent to the light source 340. The auxiliary fluorescent layer 327 may be formed in a region opposite the fluorescent band 325 based on the light source 340. The auxiliary fluorescent layer 327 may face the fluorescent band 325 in a state in which the light source 340 is disposed between the fluorescent band 325 and the auxiliary fluorescent layer 327. That is, the light source 340 may be disposed between the fluorescent band 325 and the auxiliary fluorescent layer 327.

The auxiliary fluorescent layer 327 may have the same shape as that of the fluorescent band 325. The auxiliary fluorescent layer 327 may have a size corresponding to the fluorescent band 325. The auxiliary fluorescent layer 327 may have the same height as that of the fluorescent band 325.

When the fluorescent layer 325 includes a plurality of fluorescent bands 325, the auxiliary fluorescent layer 327 may include a plurality of auxiliary fluorescent bands. A width and a separation distance of the auxiliary fluorescent layer 327 may correspond to those of the plurality of fluorescent bands 325. That is, the plurality of fluorescent bands 325 are arranged in a circular shape based on a central point of an output region 50, and the plurality of auxiliary fluorescent bands are also arranged in a circular shape based on the central point of the output region 50. The plurality of fluorescent bands 325 are arranged along a predetermined circumference. A distance from the central point to the plurality of fluorescent bands 325 is different from a distance from the central point to the plurality of auxiliary fluorescent bands. Thus, a circumference on which the plurality of the plurality of fluorescent bands are arranged is different from a circumference on which the plurality of auxiliary fluorescent bands are arranged, and a width and a separation distance of each of the auxiliary fluorescent bands may be determined to correspond to a ratio of the differing circumferences.

The auxiliary fluorescent layer 327 may be formed of the same material as a material used to form the fluorescent bands 325.

Light output from the light source 340 is reflected and output by the fluorescent bands 325 and the auxiliary fluorescent layer 327 so that a CRI of the light can be increased and light having a homogeneous wavelength range can be output.

As described above, the lighting apparatus 1 according to the fourth embodiment includes the auxiliary fluorescent layer 327 so that, even when an additional packaging process is omitted, light having a desired CCT can be output, a CRI can be increased, and light having a homogeneous wavelength range can be output. Thus, manufacturing costs can be reduced, defects in the packaging process can be prevented, and a manufacturing yield can be improved.

An angle between a top surface of the fluorescent bands 325 and a top surface of the auxiliary fluorescent layer 327 may be uniform on the basis of the light source 340. The angle may be an exit angle of light emitted from the light source 340. The exit angle may be 100° or more. Preferably, the exit angle may be 120°.

Although not shown, the auxiliary fluorescent layer 327 may be formed on a support member 330. The auxiliary fluorescent layer 327 may be formed on a first protruding region 31 of the support member 330. The auxiliary fluorescent layer 327 may be attached to the first protruding region 31, or the first protruding region 31 may be coated with a fluorescent material so that the auxiliary fluorescent layer 327 can be formed thereon.

While the invention has been shown and described with reference to certain exemplary embodiments thereof, it should be understood by those skilled in the art that various changes in form and details may be made therein without departing from the spirit and scope of the invention as defined by the appended claims.

### INDUSTRIAL APPLICABILITY

A lighting apparatus according to embodiments can be used for industrial and home lighting.

1. A lighting apparatus comprising:
a light source configured to emit light;
a reflective member included an output region of the light and surrounded the output region; and
a fluorescent layer formed on a part of a region of the reflective member.

2. The lighting apparatus of claim 1,
wherein the fluorescent layer is formed on a part of a region of the reflective member adjacent to the light source.

3. The lighting apparatus of claim 1 further comprising:
a support member disposed at one end of the reflective member and supporting the light source,
wherein the fluorescent layer is formed on a part of a region of the reflective member adjacent to the support member.

4. The lighting apparatus of claim 1,
wherein the fluorescent layer has a predetermined height.

5. The lighting apparatus of claim 4,
wherein the height of the fluorescent layer is in a range of 8 mm to 16 mm.

6. The lighting apparatus of claim 1,
wherein the fluorescent layer comprises a plurality of fluorescent bands spaced a predetermined distance apart from each other.

7. The lighting apparatus of claim 6,
wherein each of the plurality of fluorescent bands has a predetermined separation distance.

8. The lighting apparatus of claim 6,
wherein a width of each of the fluorescent bands is in a range of 5 mm to 50 mm.

9. The lighting apparatus of claim 7,
wherein the predetermined separation distance is in a range of 10 mm to 15 mm.

10. The lighting apparatus of claim 7,
wherein a ratio of a width to the predetermined separation distance of each of the fluorescent bands is in a range of 1:3 to 5:1.

11. The lighting apparatus of claim 3, further comprising:
an auxiliary fluorescent layer facing the fluorescent layer in which the light source is disposed between the fluorescent layer and the auxiliary fluorescent layer.

12. The lighting apparatus of claim 11,
wherein the auxiliary fluorescent layer has the same shape as that of the fluorescent layer.

13. The lighting apparatus of claim 11,
wherein the auxiliary fluorescent layer is applied to a protruding part of the support member.

14. The lighting apparatus of claim 11,
wherein the auxiliary fluorescent layer is formed of the same material as a material used to form the fluorescent layer.

15. The lighting apparatus of claim 1,
wherein the fluorescent layer includes an inorganic phosphor or an organic phosphor.

16. The lighting apparatus of claim 1,
wherein the fluorescent layer includes a quantum dot.

17. The lighting apparatus of claim 1,
wherein the fluorescent layer comprises a phosphor that generates an excited light having a wavelength different from that of a visible light region generated in the light source.

18. The lighting apparatus of claim 6,
wherein a ratio of a width to a height of the fluorescent layer is in a range of 8:25 to 2:25.

19. The lighting apparatus of claim 1,
wherein a height of the fluorescent layer is determined by a concentration of a phosphor included in the fluorescent layer and a size of the light source.
